(19) United States
(12) Patent Application Publication
(10) Pub. No.: US 2026/0149507 A1
(43) Pub. Date: May 28, 2026

(54) MULTI-INPUT COHERENT OPTICAL RECEIVER

(71) Applicant: Nokia Solutions and Networks Oy, Espoo (FI)

(72) Inventors: Haoshuo Chen, Aberdeen, NJ (US); Nicolas Fontaine, New Providence, NJ (US); Roland Ryf, Aberdeen, NJ (US); David Neilson, Old Bridge, NJ (US); John Simsarian, Highland Park, NJ (US)

(21) Appl. No.: 18/956,431

(22) Filed: Nov. 22, 2024

(51) Int. Cl. H04B 10/61

(52) U.S. Cl. CPC H04B 10/614; H04B 10/616

(57) ABSTRACT

Various example embodiments of a multi-input coherent optical receiver are presented. The multi-input coherent optical receiver may be configured to support coherent detection of light from a set of multiple spatially separated optical input fibers. The multi-input coherent optical receiver may be configured to support coherent detection of light from a set of multiple spatially separated optical input fibers based on use of an optical hybrid array, dispersive optics, and an optical detector array, where the optical hybrid array is configured to produce optical hybrid output light by superposing local oscillator light with the light of the plurality of optical input channels, the dispersive optics are configured to disperse the optical hybrid output light into spectral channels that are spectrally and spatially separated, and the optical detector array is configured, for each respective spectral channel of the spectral channels, to detect optical hybrid output light of the respective spectral channel.

### TECHNICAL FIELD

Various example embodiments relate generally to communication systems and, more particularly but not exclusively, to coherent optical receivers for use in optical communication systems.

### BACKGROUND

Various communications technologies may be used to support communications in various types of communication systems.

### SUMMARY

In at least some example embodiments, an apparatus includes a coherent optical receiver configured to receive light of a plurality of optical input channels, wherein the optical input channels are spatially separated and wherein the coherent optical receiver comprises an optical hybrid array, dispersive optics, and an optical detector array, wherein the optical hybrid array is configured to produce optical hybrid output light by superposing local oscillator light with the light of the plurality of optical input channels, wherein the dispersive optics are configured to disperse the optical hybrid output light into spectral channels that are spectrally and spatially separated, and wherein the optical detector array is configured, for each respective spectral channel of the spectral channels, to detect optical hybrid output light of the respective spectral channel.

In at least some example embodiments, a method includes receiving, by a coherent optical receiver, light of a plurality of optical input channels, wherein the optical input channels are spatially separated, producing, by an optical hybrid array of the coherent optical receiver, optical hybrid output light by superposing local oscillator light with the light of the plurality of optical input channels, dispersing, by dispersive optics of the coherent optical receiver, the optical hybrid output light into spectral channels that are spectrally and spatially separated, and detecting, by an optical detector array of the coherent optical receiver for each respective spectral channel of the spectral channels, optical hybrid output light of the respective spectral channel.

In at least some example embodiments, the optical hybrid array is configured to couple each optical input channel of the plurality of optical input channels to a respective group of optical hybrid output channels and to output optical hybrid output light on the group of optical hybrid output channels.

In at least some example embodiments, for each optical input channel of the plurality of optical input channels, the respective group of optical hybrid output channels comprises four optical hybrid output channels for each polarization of the respective optical input channel, wherein the optical hybrid array is configured, for each polarization of each optical input channel of the plurality of optical input channels, to superimpose light of the optical input channel with four instances of the local oscillator light, the four instances having a phase of 0 degrees, 90 degrees, 180 degrees and 270 degrees relative to a first instance among the four instances, respectively, to provide the four optical hybrid output channels for the respective polarization of the respective optical input channel.

In at least some example embodiments, the dispersive optics are configured, for each optical input channel of the plurality of optical input channels, to couple each optical hybrid output channel of the respective group of optical hybrid output channels to a respective set of spectral channels, wherein the spectral channels of the respective set of spectral channels are spectrally and spatially separated from each other.

In at least some example embodiments, the plurality of optical input channels is arranged in a two-dimensional array.

In at least some example embodiments, the optical hybrid array comprises a surface-normal optical hybrid array.

In at least some example embodiments, wherein the optical hybrid array comprises a set of patterned waveplate (PW) planes, wherein the set of PW planes comprises, a first PW plane, a second PW plane, a third PW plane, a fourth PW plane, a fifth PW plane, and a sixth PW plane, wherein the first PW plane is configured to provide a set of beams by, for each of the optical input channels, performing polarization beam splitting for the respective optical input channel to provide a respective set of optical channel beams and performing beam splitting for a respective set of local oscillator signals associated with the respective optical input channel to provide a set of local oscillator beams, wherein the second PW plane is configured to bend respective paths of the beams in the set of beams to allow for interference of the optical channel beams and the local oscillator beams at the fourth PW plane, wherein the third PW plane is configured to convert the set of beams into a set of differential beams by, for each beam in the set of beams, dividing the respective beam into a respective in-phase (I) branch and a respective quadrature (Q) branch, wherein the fourth PW plane is configured to output a set of optical signals based on mixing of the set of differential beams, wherein the fifth PW plane is configured to output a set of parallelized optical signals based on parallelization of the optical signals in the set of optical signals, wherein the sixth PW plane is configured to output the set of optical hybrid output channels based on conversion of the parallelized optical signals from circular polarization to linear polarization.

In at least some example embodiments, for each of the optical input signals, the local oscillator light superimposed with the light of the respective optical input channel is obtained based on a local oscillator optical input signal.

In at least some example embodiments, the local oscillator optical input signal is received from a remote transmitter or generated locally by a local laser source.

In at least some example embodiments, the dispersive optics comprise a diffraction grating configured to spectrally decompose the optical hybrid output light into the spectral channels.

In at least some example embodiments, the coherent optical receiver further includes a set of optics elements configured to direct the optical hybrid output light toward the dispersive optics and configured to direct the optical hybrid output light of the spectral channels toward the optical detector array.

In at least some example embodiments, the set of optics elements includes an optical circulator.

In at least some example embodiments, the optical circulator comprises a Faraday rotator and a 45-degree half waveplate (HWP).

In at least some example embodiments, the set of optics elements comprises a set of collimating lenses, a diffraction grating, a set of spectrometer lenses, and a set of steering elements.

In at least some example embodiments, the set of optics elements comprises a steering device configured to direct the spectral channels to be incident on optical detector elements of the optical detector array, respectively.

In at least some example embodiments, the steering device comprises a passive steering device.

In at least some example embodiments, the steering device comprises an active steering device.

In at least some example embodiments, the active steering device comprises a liquid crystal on silicon (LCoS) device, wherein the LCoS device is configured to apply a grating pattern to control respective steering angles configured to cause the respective spectral channels to be incident on respective optical detector elements of the optical detector array.

In at least some example embodiments, further comprising a controller configured to control the active steering device based on feedback from the optical detector array.

In at least some example embodiments, an apparatus includes means for receiving light of a plurality of optical input channels, wherein the optical input channels are spatially separated, means for producing optical hybrid output light by superposing local oscillator light with the light of the plurality of optical input channels, means for dispersing the optical hybrid output light into spectral channels that are spectrally and spatially separated, and means for detecting, for each respective spectral channel of the spectral channels, optical hybrid output light of the respective spectral channel.

### BRIEF DESCRIPTION OF THE DRAWINGS

The teachings herein can be readily understood by considering the following detailed description in conjunction with the accompanying drawings, in which:

FIG. 1 depicts an example embodiment of an optical communication system including a multi-input coherent optical receiver having an optical hybrid array, dispersive optics, and an optical detector array;

FIG. 2 depicts an example embodiment of a multi-input coherent optical receiver for use as the multi-input coherent optical receiver of FIG. 1;

FIG. 3 depicts an example embodiment of an optical hybrid array for use in the multi-input coherent optical receiver of FIG. 2;

FIG. 4 depicts a top view and a side view of the multi-input coherent optical receiver of FIG. 2;

FIG. 5 depicts an example embodiment of a multi-input coherent optical receiver for use as the multi-input coherent optical receiver of FIG. 1;

FIG. 6 depicts an example embodiment of a method for operating a multi-input coherent optical receiver having an optical hybrid array, dispersive optics, and an optical detector array; and

FIG. 7 depicts an example embodiment of a computer suitable for use in performing various functions presented herein.

To facilitate understanding, identical reference numerals have been used herein, wherever possible, in order to designate identical elements that are common among the various figures.

### DETAILED DESCRIPTION

Various example embodiments of a multi-input coherent optical receiver are presented. The multi-input coherent optical receiver may be configured to support coherent detection of light from a set of multiple spatially separated optical input fibers. The multi-input coherent optical receiver may be configured to support coherent detection of light from a set of multiple spatially separated optical input fibers based on use of an optical hybrid array, dispersive optics, and an optical detector array, where the optical hybrid array is configured to produce optical hybrid output light by superposing local oscillator light with the light of the plurality of optical input channels, the dispersive optics are configured to disperse the optical hybrid output light into spectral channels that are spectrally and spatially separated, and the optical detector array is configured, for each respective spectral channel of the spectral channels, to detect optical hybrid output light of the respective spectral channel. It will be appreciated that these example embodiments of a multi-input coherent optical receiver, as well as various other example embodiments of a multi-input coherent optical receiver, may be further understood by way of reference to the figures and associated description of those figures, which follows.

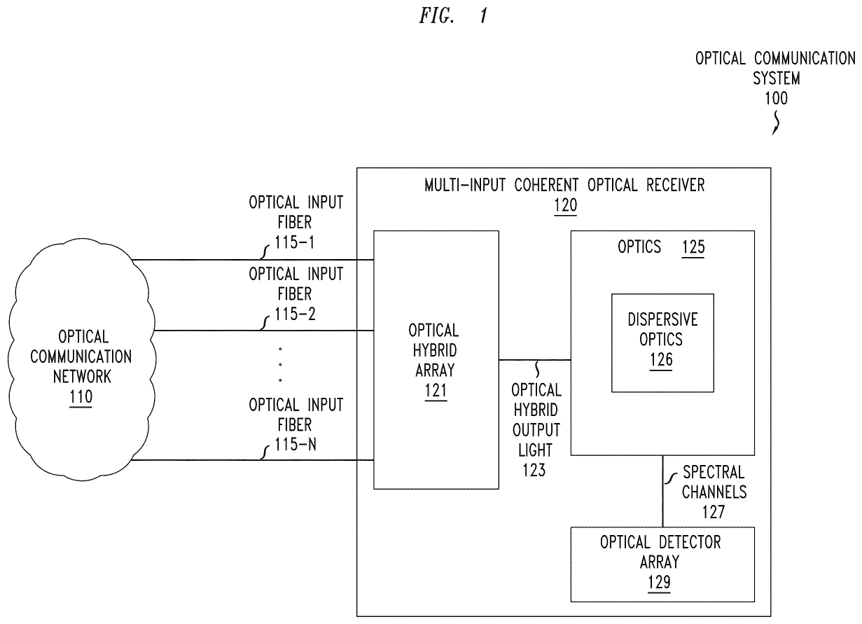

FIG. 1 depicts an example embodiment of an optical communication system including a multi-input coherent optical receiver having an optical hybrid array, dispersive optics, and an optical detector array.

As depicted in FIG. 1, an optical communication system 100 includes an optical network 110 and a multi-input coherent optical receiver 120. The optical communication network 110 may include any optical communication network configured to support optical communications, and the multi-input coherent optical receiver 120 may be disposed within various types of optical communications devices depending on the optical communication network 110 in which the multi-input coherent optical receiver 120 is utilized. For example, the optical communication network 110 may be an active optical network (AON) or a passive optical network (PON). For example, within the context of a PON, the multi-input coherent optical receiver 120 may be disposed within an optical line terminal (OLT) for upstream communications or an optical network unit (ONU) for downstream communications. It will be appreciated that the multi-input coherent optical receiver 120 may be disposed within various other optical communications devices depending on various characteristics of the optical communication network 110 in which the multi-input coherent optical receiver 120 is utilized.

The optical communication network 110 is configured to provide a set of optical input fibers 115-1 to 115-N (collectively, optical input fibers 115, where N≥2) which terminate on the multi-input coherent optical receiver 120. The optical input fibers 115 are spatially separated from each other at the point of connection to the multi-input coherent optical receiver 120, thereby providing multiple optical input channels that can be spatially and spectrally separated to provide a set of spatially and spectrally separated spectral channels that can be resolved by the multi-input coherent optical receiver 120. For example, the optical input fibers 115 may interface with the multi-input coherent optical receiver 120 as an array, such as a one-dimensional (1D) array or a two-dimensional (2D) array. For example, the optical input fibers 115 may include multiple single mode fibers (SMF), multiple optical cores of one or more multimode fibers (MMFs), multiple fibers of one or more optical ribbons, or the like, as well as various combinations thereof. It will be appreciated that the multiple optical input channels may be received by the multi-input coherent optical receiver 120 from the optical communication network 110 in other ways.

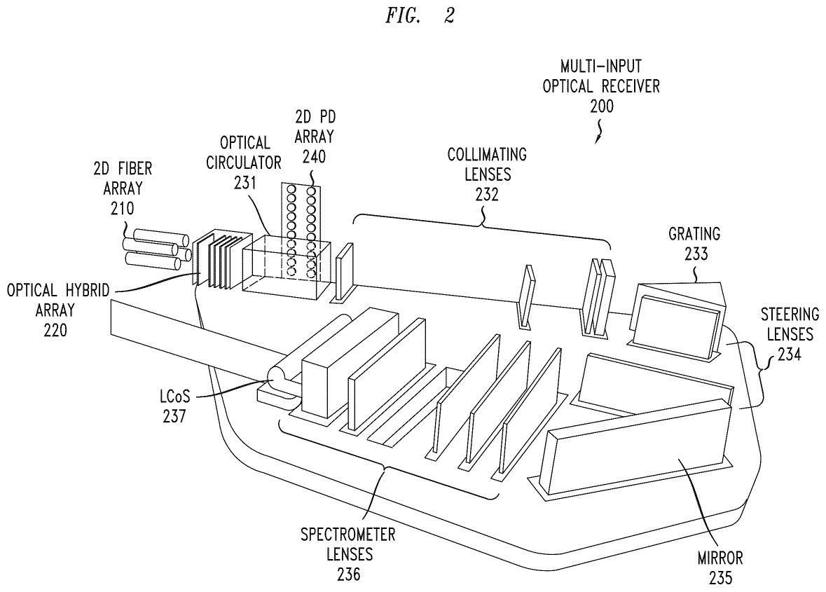

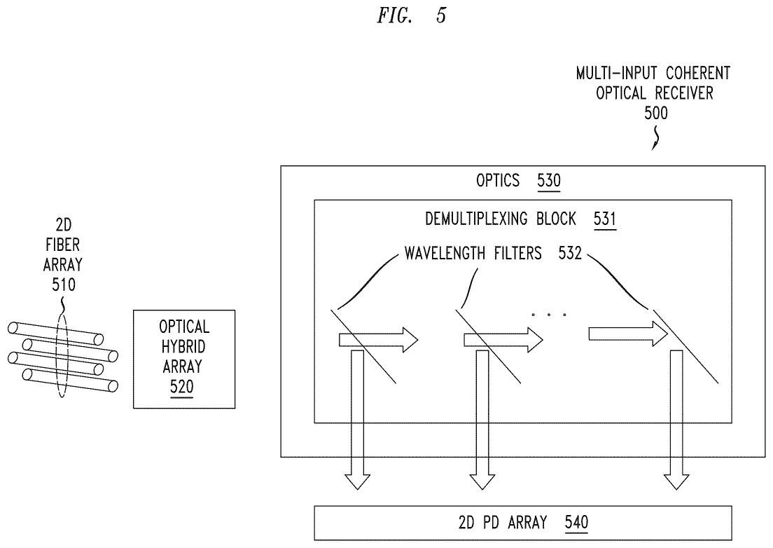

The multi-input coherent optical receiver 120 is configured to support coherent reception of spectral channels from optical input channels received from the optical communication network 110 via the optical input fibers 115. The multi-input coherent optical receiver 120 includes an optical hybrid array 121, optics 125, and an optical detector array 129. The optical hybrid array 121 is a surface-normal optical hybrid array that is configured to produce optical hybrid output light 123 by superposing local oscillator light with light of the optical input channels. The optics 125 include dispersive optics 126 configured to disperse the optical hybrid output light 123 from the optical hybrid array 121 into spectral channels 127 that are spectrally and spatially separated. The optics 125 also include other optics elements configured to direct the optical hybrid output light 123 from the optical hybrid array 121 to the dispersive optics 126 and configured to direct the optical hybrid output light 123 of the spectral channels 127 from the dispersive optics 126 to the optical detector array 129. The optical detector array 129 is arranged to receive the optical hybrid output light 123 of the spectral channels 127 via the optics 125 and, for each respective spectral channel 127, detect optical hybrid output light 123 of the respective spectral channel 127, thereby enabling the optical detector array 129 to resolve the individual spectral channels 127. It is noted that example embodiments of the multi-input coherent optical receiver 120 are presented with respect to FIG. 2 and FIG. 5, although it will be appreciated that other implementations of the multi-input coherent optical receiver 120 are contemplated.

The optical hybrid array 121, as indicated above, is configured to produce optical hybrid output light 123 by superposing local oscillator light with light of the optical input channels. The local oscillator light that is superimposed with the light of the optical input channels may be obtained based on local oscillator optical input signals (e.g., each optical input channel has an associated local oscillator optical input signal such that the light of the respective optical input channel is superimposed with the local oscillator light of the respective local oscillator optical input signal for the respective optical input channel). The local oscillator optical input signals may be received from a remote transmitter (e.g., received via the optical communication network 110), generated locally by a local laser source (e.g., a local laser source co-located with the multi-input coherent optical receiver 120), or the like.

The optical hybrid array 121 may be configured to couple the optical input channels to groups of optical hybrid output channels and to output the optical hybrid output light 123 on the groups of optical hybrid output channels, respectively. The optical hybrid array 121 may be configured to support various combinations of polarization states and quadrature states to produce the optical hybrid output light 123 for the optical hybrid output channels. For example, the optical hybrid array 121 may be configured to support a single polarization or dual polarizations. For example, the optical hybrid array 121 may be configured to support a set of quadrature states (e.g., two quadrature states with 180 degree relative phase offset, four quadrature states with 90 degree relative phase offset, or the like). For example, the optical hybrid array 121 may be a 90-degree optical hybrid array configured, for each polarization of each optical input channel of the optical input channels, to superimpose light of the optical input channel with four instances of the local oscillator light, the four instances having a phase of 0 degrees, 90 degrees, 180 degrees and 270 degrees relative to a first instance among the four instances, respectively, to provide four optical hybrid output channels for the respective polarization of the respective optical input channel. In this manner, the optical hybrid array may be configured such that, for each of the optical input channels, the respective group of optical hybrid output channels includes four optical hybrid output channels for each polarization of the respective optical input channel (e.g., four optical hybrid output channels for the case of a single polarization, eight optical hybrid output channels for the case of dual polarizations, and so forth).

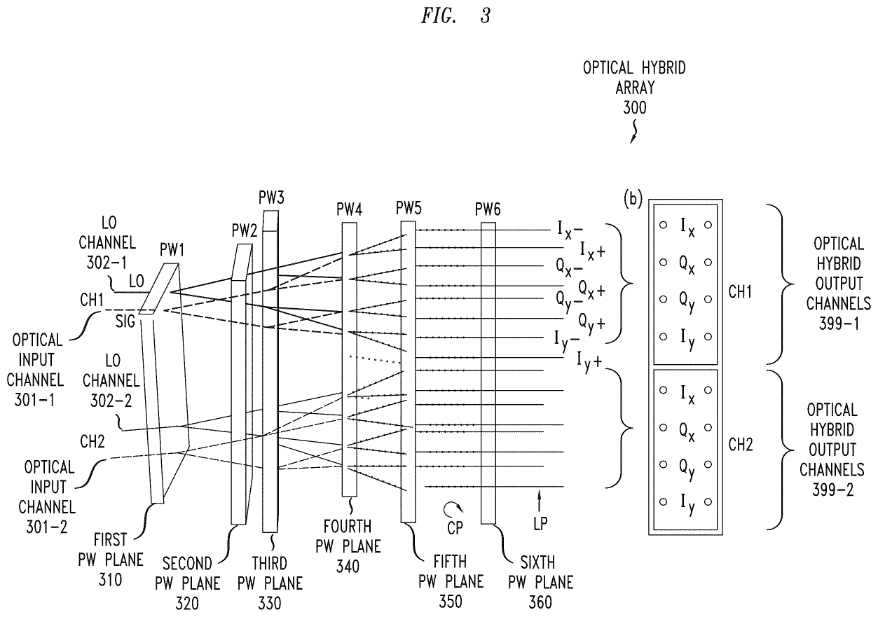

The optical hybrid array 121 may be configured to couple the optical input channels to the groups of optical hybrid output channels and to output the optical hybrid output light 123 on the groups of optical hybrid output channels, respectively, based on a set of patterned waveplate (PW) planes. The set of PW planes may be configured to provide a set of beams including optical channel beams based on polarization beam splitting of optical input channels and local oscillator signals based on polarization beam splitting of the local oscillator signals, convert the set of beams into differential beams by dividing each of the beams into a respective in-phase (I) branch and a respective quadrature (Q) branch, output a set of optical signals based on mixing of differential beams in the set of differential beams, output a set of parallelized optical signals based on parallelization of the optical signals in the set of optical signals, and output the set of optical hybrid output channels based on conversion of the parallelized optical signals from circular polarization to linear polarization. It is noted that an example embodiment of implementation of the optical hybrid array 121 based on a set of PW planes is presented with respect to FIG. 3.

It will be appreciated that the optical hybrid array 121 may be configured to produce optical hybrid output light 123, by superposing local oscillator light with light of the optical input channels, in various other ways.

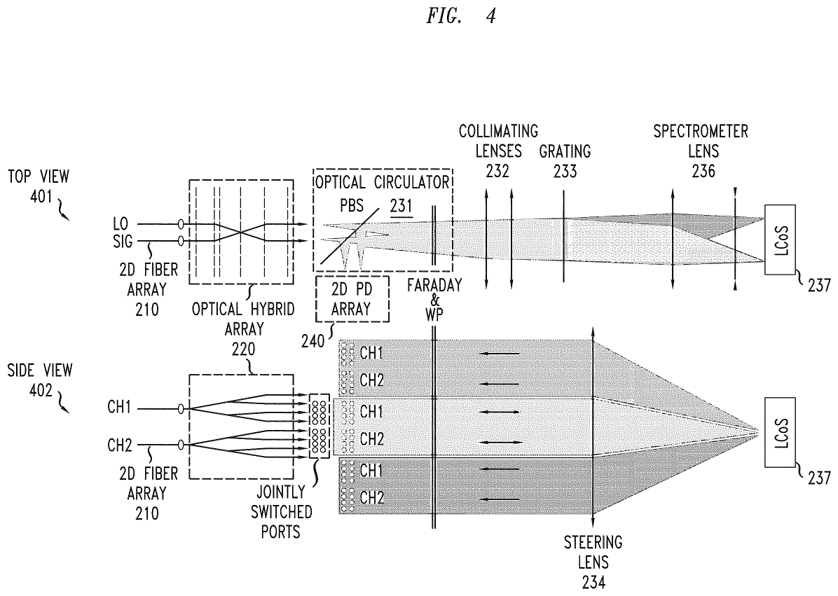

The optics 125, as indicated above, include the dispersive optics 126 configured to disperse the optical hybrid output light 123 from the optical hybrid array 121 into spectral channels 127 that are spectrally and spatially separated. The dispersive optics 126 may be configured such that, for each optical input channel, each optical hybrid output channel of the respective group of optical hybrid output channels for the respective optical input channel is coupled to a respective set of spectrally and spatially separated spectral channels. For example, the dispersive optics 126 may include a diffraction grating configured to spectrally decompose the optical hybrid output light 123 into the spectral channels 127. It is noted that example embodiments of the dispersive optics 126 are presented with respect to FIG. 2, FIG. 4, and FIG. 5. It is noted that the dispersive optics 126 may include various other elements configured to disperse the optical hybrid output light 123 from the optical hybrid array 121 into the spectral channels 127 that are spectrally and spatially separated.

The optics 125 also include other optics elements configured to direct the optical hybrid output light 123 from the optical hybrid array 121 to the dispersive optics 126 and configured to direct the optical hybrid output light 123 of the spectral channels 127 from the dispersive optics 126 to the optical detector array 129. For example, the optics 125 may include an optical circulator configured to direct the optical hybrid output light 123 toward the dispersive optics 126 and configured to direct the optical hybrid output light 123 of the spectral channels 127 toward the optical detector array 129. For example, the optics 125 may include an optical spectrometer. For example, the optics 125 may include a set of collimating lenses, a set of spectrometer lenses, and a set of steering elements. For example, the optics 125 may include a steering device configured to direct the optical hybrid output light 123 of the spectral channels 127 to be incident on optical detector elements of the optical detector array 129, respectively, where the steering device may include an active steering device (e.g., an LCoS device configured to apply a grating pattern to control steering angles configured to cause the optical hybrid output light 123 of the spectral channels 127 to be incident on the optical detector array 129, example embodiments of which are presented with respect to FIG. 2 and FIG. 4) or a passive steering device (e.g., a demultiplexing block including an array of wavelength filters configured to cause the optical hybrid output light 123 of the spectral channels 127 to be incident on the optical detector array 129, an example embodiment of which is presented with respect to FIG. 5). It will be appreciated that the optics 125 may include other optics elements configured to direct the optical hybrid output light 123 from the optical hybrid array 121 to the dispersive optics 126 and configured to direct the optical hybrid output light 123 of the spectral channels 127 from the dispersive optics 126 to the optical detector array 129.

The optical detector array 129, as indicated above, is arranged to receive the optical hybrid output light 123 via the dispersive optics 125 and, for each respective spectral channel 127, detect optical hybrid output light 123 of the respective spectral channel 127, thereby enabling the optical detector array 129 to resolve the individual spectral channels 127. The optical detector array 129 may include an array of optical detector elements configured to detect the optical hybrid output light 123 of the spectral channels 127. The optical detector array 129 may include a two-dimensional array of optical detector elements. The optical detector elements of the optical detector array 129 may include photodiodes or other suitable types of optical detector elements configured to detect the optical hybrid output light 123 of the spectral channels 127. It will be appreciated that the arrangement of the optical detector array 129 relative to the optical hybrid array 121 and the optical detector array 129 may be further understood by way of reference to FIG. 2, FIG. 4, and FIG. 5.

It will be appreciated that the multi-input coherent optical receiver 120 may include various other elements which may be used to support coherent reception of spectral channels from optical input channels received from the optical communication network 110 via the optical input fibers 115.

FIG. 2 depicts an example embodiment of a multi-input coherent optical receiver for use as the multi-input coherent optical receiver of FIG. 1.

As depicted in FIG. 2, the multi-input coherent optical receiver 200 includes a two-dimensional (2D) fiber array 210, an optical hybrid array 220, an optical circulator 231, a set of collimating lenses 232, a grating 233, a set of steering lenses 234, a mirror 235, a set of spectrometer lenses 236, and a liquid-crystal-on-silicon (LCoS) 237, and a two-dimensional (2D) photodetector (PD) array 240. The multi-input coherent optical receiver 200 of FIG. 2 may correspond to the multi-input coherent optical receiver 100 of FIG. 1 as follows: (1) the 2D fiber array 210 may correspond to the optical input fibers 115 of FIG. 1, (2) the optical hybrid array 220 may correspond to the optical hybrid array 121 of the multi-input coherent optical receiver 120 of FIG. 1, (3) the optical circulator 231, the set of collimating lenses 232, the grating 233, the set of steering lenses 234, the mirror 235, the set of spectrometer lenses 236, and the LCoS 237 may correspond to the optics 125 of the multi-input coherent optical receiver 120 of FIG. 1, with the grating 233 corresponding to the dispersive optics 126 of the optics 125, and (4) the 2D PD array 240 may correspond to the optical detector array 129 of the multi-input coherent optical receiver 120 of FIG. 1. In FIG. 2, the steering device configured to direct the spectral channels to be incident on optical detector elements of the 2D PD array 240 is an active steering device (illustratively, LCoS 237).

The 2D fiber array 210 supports a pair of optical input channels. This is illustrated as four optical channels as each optical input channel has a local oscillator (LO) channel associated therewith. The optical input channels are received via optical input fibers of the 2D fiber array 210 that interface with the optical hybrid array 220. The LO channels for the optical input channels are received via LO fibers of the 2D fiber array 210 that interface with the optical hybrid array 220. The LO channels for the optical input channels may be received from a remote LO source (e.g., from a transmitter at the source of the input optical channels) or a local LO source (e.g., from an LO laser on the multi-input coherent optical receiver 200 or from a LO laser on an optical device within which the multi-input coherent optical receiver 200 is disposed). It will be appreciated that, although primarily presented as supporting two optical input channels, more than two optical input channels may be supported (in which case the 2D fiber array 210 may include additional input fibers for additional optical input channels and associated LO channels of the additional optical input channels).

The optical hybrid array 220 is a surface-normal optical hybrid array. The optical hybrid array 220 is configured to produce optical hybrid output light by superposing local oscillator light of LO channels with optical input light of the optical input channels. The optical hybrid array 220, for each of the optical input channels, produces optical hybrid output light for the optical input channel based on superposition of the LO light of the respective LO channel with the optical input light of the respective optical input channel, such that the respective optical input channel is coupled to a group of optical hybrid output channels for outputting optical hybrid output light on the group of optical hybrid output channels. The optical hybrid array 220, as illustrated in FIG. 3, may be a dual-polarization 90-degree optical hybrid array configured to support, for each of the optical input channels, four quadrature states (namely, 0-degree, 90-degree, 180-degree, and 270-degree) in the complex field space for each of the two polarizations (namely, for the X polarization and the Y polarization), thereby resulting in eight optical hybrid output channels ({Ix−, Ix+, Qx−, Qx+, Qy−, Qy+, Iy−, Iy+}) for the optical input channel, respectively. The group of optical hybrid output channels from the optical hybrid array is coupled to the optical circulator 231. It is noted that an example embodiment of an optical hybrid array suitable for use as the optical hybrid array 220 is presented with respect to FIG. 3.

The optical circulator 231 is configured to support interfacing for the optics. The optical circulator 231 is configured to support coupling of the optical hybrid output channels from the optical hybrid array 220 for propagation through the optics to the grating 233, thereby enabling optical dispersion of the optical hybrid output channels by the dispersion grating 233 to form the set of spectral channels to be detected by the 2D PD array 240. The optical circulator 231 is also configured to support coupling of the spectral channels received back through the optics to the 2D PD array 240, thereby enabling detection of the optical hybrid output light of the spectral channels, respectively, by the 2D PD array 240. The optical circulator 231 may include a polarization beam splitter (PBS) as well as a Faraday rotator and a 45-degree half waveplate (HWP). It will be appreciated that the optical circulator 231 may include various other components or combinations of components.

The optics are configured to support propagation of the optical hybrid output channels from the optical hybrid array 220 for spectral dispersion, spectral dispersion of the optical hybrid output channels to produce spectral channels, and propagation of the spectral channels back toward the optical circulator 231 for coupling to the 2D PD array 240. In the input direction, the optical hybrid output channels are passed through the collimating lenses 232 to the grating 233, the optical hybrid output channels are dispersed by the grating 233 to form the spectral channels, and the spectral channels are redirected by steering lenses 234 and the mirror 235 and passed through the spectrometer lenses 236 such that the spectral channels are incident on the LCoS 237. The LCoS 237 is configured to operate as an active steering device configured to apply a grating pattern to control steering angles configured to cause the spectral channels to be incident on the 2D PD array 240. The LCoS 237 is configured to direct the spectral channels back through the optics to be incident on the 2D PD array 240. In the return direction, the spectral channels are passed through the spectrometer lenses 236, redirected by the mirror 235 and the steering lenses 234, passed through the collimating lenses 232, and then redirected by the optical circulator 231 such that the optical hybrid output light of the spectral channels is incident on the 2D PD array 240.

The 2D PD array 240 is configured to detect the spectral channels which have been produced from the input optical channels. The 2D PD array 240 includes a 2D array of optical detector elements (illustrated as pairs of optical detector elements arranged as two columns, with each row corresponding a pair of optical detector elements, respectively). The optical detector elements may include any optical detector elements suitable for detecting the spectral channels, such as photodiodes or other suitable types of optical detector elements. In the 2D PD array 240, the pairs of optical detector elements may operate as balanced photodetectors, respectively, the output of which may then be provided to downstream elements for further conversion and processing for signal recovery. For example, although omitted for purposes of clarity, it will be appreciated that the outputs of the balanced photodetectors may be provided to transimpedance amplifiers (TIAs), respectively, which may convert the outputs of the balanced photodetectors into voltage signals which are provided to analog-to-digital converters (ADCs), respectively, for conversion into digital signals for further processing by a digital signal processor (DSP). In this manner, the 2D PD array 240 supports detection of the spectral channels recovered from the input optical signals in a manner that enables recovery of the data propagated via the input optical channels received via the 2D fiber array 210 at the multi-input coherent optical receiver 200.

FIG. 3 depicts an example embodiment of an optical hybrid array for use in the multi-input coherent optical receiver of FIG. 2.

As depicted in FIG. 3, optical hybrid array 300 is a surface-normal dual-polarization 90-degree optical hybrid array supporting a pair of optical input channels 301-1 and 301-2 (collectively, optical input channels 301, which also are designated as signal channels) and producing optical hybrid output channels 399 for the optical input channels 301. The optical hybrid array 300 superimposes LO light from a pair of LO channels 302-1 and 302-2 (collectively, LO channels 302) on optical input light from the optical input channels 301-1 and 301-2, respectively, to produce the optical hybrid output channels 399. The optical hybrid array 300 supports dual polarization and four quadrature states associated with the LO channels 302 in the complex field space (namely, quadrature states with 0-degree, 90-degree, 180-degree, and 270-degree relative phase shifts), thereby resulting in eight optical hybrid output channels 399 for each of the optical input channels 301 (four for the X polarization based on the and four quadrature states for four for the Y polarization based on the four quadrature states). Namely, the optical hybrid array 300 outputs a first set of optical hybrid output channels 399-1 (including eight optical hybrid output channels denoted as {Ix−, Ix+, Qx−, Qx+, Qy−, Qy+, Iy−, Iy+}) based on the two (X+Y) polarization states of the optical input channel 301-1 and the four quadrature states of associated LO channel 302-1 and outputs a second set of optical hybrid output channels 399-2 (including eight optical hybrid output channels denoted as {Ix−, Ix+, Qx−, Qx+, Qy−, Qy+, Iy−, Iy+}) based on the two (X+Y) polarization states of the optical input channel 301-2 and the four quadrature states of the LO channel 302-1. As depicted in FIG. 3, the pair of optical input channel 301-1 and LO channel 302-1 and its associated set of optical hybrid output channels 399-1 is denoted as channel 1 (CH1) and the pair of optical input channel 301-2 and LO channel 302-2 and its associated set of optical hybrid output channels 399-2 is denoted as channel 2 (CH2).

As depicted in FIG. 3, the optical hybrid array 300 is composed of six patterned waveplate (PW) planes including a first PW plane 310, a second PW plane 320, a third PW plane 330, a fourth PW plane 340, a fifth PW plane 350, and a sixth PW plane 360. The first PW plane serves as a PBS for both the optical input channels 301 and the LO channels 302, thereby resulting in two optical input channel beams for each of the optical input channels 301 and two LO beams for each of the LO channels 302 (i.e., 8 total beams, including 4 beams for CH1 and 4 beams for CH2). The second PW plane 320 bends the light paths of the beams from the first PW plane 310 to allow interference of beams at the fourth PW plane 340. The third PW plane divides each beam from the second PW plane 320 into two branches, in-phase (I) and quadrature (Q), thereby resulting in four optical input channel beams for each of the optical input channels 301 and four LO beams for each of the LO channels 302 (i.e., 16 total beams, including 8 beams for CH1 and 8 beams for CH2). The fourth PW plane 340 mixes optical input channel beams and LO beams to produce optical hybrid output beams for the optical hybrid output channels 399 (e.g., as a coupler, such as a 3-dB coupler, or based on other types of mixing devices). The fifth PW plane 350 parallelizes the optical hybrid output beams (e.g., by compensating angles). The sixth PW plane 360 converts the optical hybrid output beams from circularly polarized output beams into linearly polarized output beams, which may match the state of polarization of associated dispersive optics, thereby producing the optical hybrid output channels 399 which are output by the optical hybrid array 300.

It will be appreciated that the optical hybrid array 300, although primarily presented with respect to supporting a specific number of optical input channels 301, may be scaled to support additional optical input channels. It will be appreciated that the optical hybrid array 300 may be configured in various other ways to receive the optical input channels 301 and output the optical hybrid output channels 399.

FIG. 4 depicts a top view and a side view of the multi-input coherent optical receiver of FIG. 2.

As depicted in the top view 401 of FIG. 4 (which illustrates the wavelength direction), each optical input channel of the 2D fiber array 210 includes an optical input channel and an associated LO channel, which are interfaced to the optical hybrid array 220. It will be appreciated that only one of the optical input channel of the 2D fiber array 210 is illustrated as the view of the other optical channel of the 2D fiber array 210 is obstructed (i.e., below the depicted channel). The optical hybrid array 220 produces optical hybrid output light for the optical input channel based on superposition of the LO light of the LO channel with the optical input light of the optical input channel, such that the optical input channel is coupled to a group of optical hybrid output channels for outputting optical hybrid output light on the group of optical hybrid output channels. The group of optical hybrid output channels is coupled to the optical circulator 231, which is composed of a PBS as well as a Faraday rotator and a 45-degree HWP. The optical hybrid output channels are then passed through the collimating lenses 232 and dispersed by the grating 233 to form the spectral channels. The spectral channels produced by the grating are then passed through the spectrometer lenses 236 such that the spectral channels are incident on the LCoS 237. The LCoS 237 may be controlled by the LCoS controller 238, which may be configured to control the pattern applied on the LCoS 237 to direct the spectral channels to be incident on the PDs of the 2D PD array 240. The LCoS 237 directs the optical hybrid output light of the spectral channels back through the various optics to the optical circulator 231 which then directs the optical hybrid output light of the spectral channels to be incident on PDs of the 2D PD array 240. It will be appreciated that the system forms a 4-f relay with the grating 233 being used to disperse the light on the LCoS 237.

As depicted in the side view 402 of FIG. 4 (which illustrates the steering direction), each optical input channel of the 2D fiber array 210 is interfaced to the optical hybrid array 220. It will be appreciated that only the optical input channels of the 2D fiber array 210 are illustrated as the view of the associated LO signals associated with the optical input channels of the 2D fiber array 210 are obstructed. The optical hybrid array 220 produces optical hybrid output light for each of the optical input channels, based on superposition of LO light of LO channels with optical input light of the optical input channels, such that the optical input channels are coupled to groups of optical hybrid output channels for outputting optical hybrid output light on the groups of optical hybrid output channels for the optical input channels, respectively. The groups of optical hybrid output channels for the optical input channels that are output by the optical hybrid array 220 are treated as a joint switch group. The groups of optical hybrid output channels for the optical input channels that are output by the optical hybrid array 220 pass through the Faraday rotator and HWP. The spectral channels associated with the groups of optical hybrid output channels for the optical input channels are also passed through the steering lenses 234 which direct the spectral channels associated with the groups of optical hybrid output channels for the optical input channels such that the spectral channels are incident on the LCoS 237. The LCoS 237 may be controlled by the LCoS controller 238, which may be configured to control the pattern applied on the LCoS 237 to direct the spectral channels to be incident on the PDs of the 2D PD array 240. The LCoS 237 directs the optical hybrid output light of the spectral channels back through the various optics to the optical circulator 231 which then directs the optical hybrid output light of the spectral channels to be incident on PDs of the 2D PD array 240. It will be appreciated that, by projecting blazed saw-tooth holograms onto the LCoS 237, all of the spectral beams may be steered to different ports simultaneously. It will be appreciated that the system forms a 2-f relay that converts the steering angle of the LCoS 237 to the port positions of the PDs of the 2D PD array 240.

FIG. 5 depicts an example embodiment of a multi-input coherent optical receiver for use as the multi-input coherent optical receiver of FIG. 1.

As depicted in FIG. 5, the multi-input coherent optical receiver 500 includes a two-dimensional (2D) fiber array 510, an optical hybrid array 520, optics 530 including a demultiplexing block 531 having an array of wavelength filters 532, and a 2D PD array 540. The multi-input coherent optical receiver 500 of FIG. 5 may correspond to the multi-input coherent optical receiver 100 of FIG. 1 as follows: (1) the 2D fiber array 510 may correspond to the optical input fibers 115 of FIG. 1, (2) the optical hybrid array 520 may correspond to the optical hybrid array 121 of the multi-input coherent optical receiver 120 of FIG. 1, (3) the optics 520 may correspond to the optics 125 of the multi-input coherent optical receiver 120 of FIG. 1, and (4) the 2D PD array 540 may correspond to the optical detector array 129 of the multi-input coherent optical receiver 120 of FIG. 1. In FIG. 5, the steering device configured to direct the spectral channels to be incident on optical detector elements of the 2D PD array 540 is a passive steering device (illustratively, demultiplexing block 531 of the optics 530).

As depicted in FIG. 5 and noted above, the multi-input coherent optical receiver 500 is similar to the multi-input coherent optical receiver 200 of FIG. 2, with the exception that at least some of the optics of FIG. 2 are replaced by static optical elements. The 2D fiber array 510 supports a pair of optical input channels, illustrated as four optical channels as each optical input channel has an LO channel associated therewith. The optical hybrid array 520 is a surface-normal optical hybrid array configured to produce optical hybrid output light by superposing local oscillator light of LO channels with optical input light of the optical input channels. The demultiplexing block 530 is configured to support static routing of the optical hybrid output light from the optical hybrid array 520 to the 2D PD array 540. The demultiplexing block 530 includes an array of wavelength filters 532 configured to filter different wavelengths, thereby enabling propagation of the light of the optical hybrid output channels from the optical hybrid array 520 toward the 2D PD array 540 for detection by the 2D PD array 540.

It will be appreciated that the multi-input coherent optical receiver 500 may include various other optics configured to support propagation of the optical hybrid output channels from the optical hybrid array 520 for spectral dispersion, spectral dispersion of the optical hybrid output channels to produce spectral channels, and propagation of the spectral channels back toward the 2D PD array 540 for coupling to the 2D PD array 540.

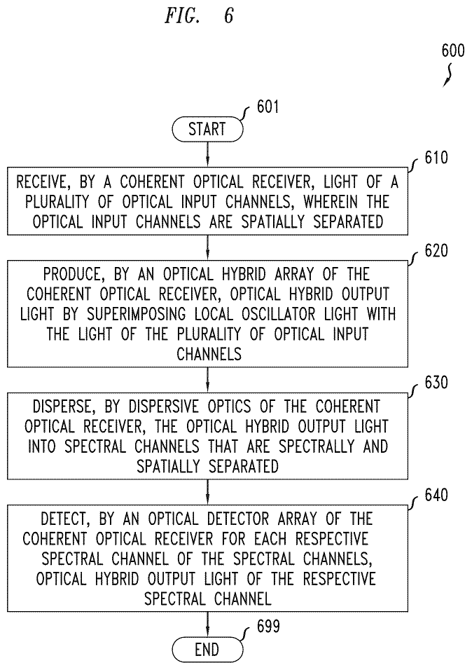

FIG. 6 depicts an example embodiment of a method for operating a multi-input coherent optical receiver having an optical hybrid array, dispersive optics, and an optical detector array. It will be appreciated that, although primarily presented herein as being performed serially, at least a portion of the functions of method 600 may be performed contemporaneously or in a different order than as presented in FIG. 6. At block 601, the method 600 begins. At block 610, receive, by a coherent optical receiver, light of a plurality of optical input channels, wherein the optical input channels are spatially separated. At block 620, produce, by an optical hybrid array of the coherent optical receiver, optical hybrid output light by superposing local oscillator light with the light of the plurality of optical input channels. At block 630, disperse, by dispersive optics of the coherent optical receiver, the optical hybrid output light into spectral channels that are spectrally and spatially separated. At block 640, detect, by an optical detector array of the coherent optical receiver for each respective spectral channel of the spectral channels, optical hybrid output light of the respective spectral channel. At block 699, the method 600 ends.

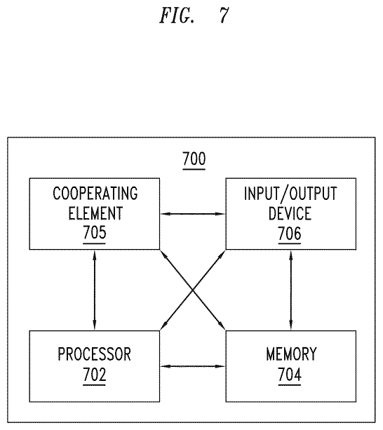

FIG. 7 depicts an example embodiment of a computer suitable for use in performing various functions presented herein.

The computer 700 includes a processor 702 (e.g., a central processing unit (CPU), a graphics processing unit (GPU), a network processing unit (NPU), a processor, a processor core of a processor, a subset of processor cores of a processor, a set of processor cores of a processor, or the like) and a memory 704 (e.g., a random access memory (RAM), a read-only memory (ROM), or the like). In at least some example embodiments, the computer 700 may include at least one processor and at least one memory storing instructions that, when executed by the at least one processor, cause the computer 700 to perform various functions presented herein.

The computer 700 also may include a cooperating element 705. The cooperating element 705 may be a hardware device. The cooperating element 705 may include firmware. The cooperating element 705 may be a process that can be loaded into the memory 704 and executed by the processor 702 to implement various functions presented herein (in which case, for example, the cooperating element 705 (including associated data structures) can be stored on a non-transitory computer readable medium, such as a storage device or other suitable type of storage element (e.g., a magnetic drive, an optical drive, or the like)).

The computer 700 also may include one or more input/output devices 706. The input/output devices 706 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 700 may represent a general architecture and functionality suitable for implementing functional elements described herein, portions of functional elements described herein, or the like, as well as various combinations thereof. For example, the computer 700 may be used to implement one or more controllers configured to control various elements of a multi-input coherent optical receiver (e.g., a controller for controlling a grating pattern on an LCoS, a controller for controlling a feedback loop from the optical detector array to an LCoS, or the like, as well as various combinations thereof).

It will be appreciated that various functions presented herein may be implemented within hardware, a combination of hardware and software, or the like. For example, at least some of the functions presented herein may be implemented in hardware (e.g., using a general purpose computer, one or more application specific integrated circuits, and/or any other hardware equivalents). For example, at least some of the functions presented herein may be implemented in a combination of hardware and software (e.g., via implementation of software on one or more processors, for executing on a general purpose computer (e.g., via execution by one or more processors) so as to provide a special purpose computer, and the like).

It will be appreciated that at least some of the functions presented herein may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored within non-transitory computer-readable media, such as within memory within a computing device operating according to the instructions, within fixed or removable media, or the like. It will be appreciated that the term “non-transitory” as used herein is a limitation of the medium itself (i.e., tangible, not a signal) as opposed to a limitation of data storage persistency (e.g., RAM versus ROM).

It will be appreciated that, as used herein, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other network or computing.

It will be appreciated that the term “non-transitory” as used herein is a limitation of the medium itself (i.e., tangible, not a signal) as opposed to a limitation of data storage persistency (e.g., RAM versus ROM).

It will be appreciated that, as used herein, “at least one of <a list of two or more elements>” and “at least one of the following: <a list of two or more elements>” and similar wording, where the list of two or more elements are joined by “and” or “or”, mean at least any one of the elements, or at least any two or more of the elements, or at least all the elements.

It will be appreciated that, as used herein, the term “or” refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

1-20. (canceled)

21. An apparatus, comprising:
a coherent optical receiver configured to receive light of a plurality of optical input channels, wherein the optical input channels are spatially separated and wherein the coherent optical receiver comprises an optical hybrid array, dispersive optics, and an optical detector array;
wherein the optical hybrid array is configured to produce optical hybrid output light by superposing local oscillator light with the light of the plurality of optical input channels;
wherein the dispersive optics are configured to disperse the optical hybrid output light into spectral channels that are spectrally and spatially separated; and
wherein the optical detector array is configured, for each respective spectral channel of the spectral channels, to detect optical hybrid output light of the respective spectral channel.

22. The apparatus of claim 21, wherein the optical hybrid array is configured to couple each optical input channel of the plurality of optical input channels to a respective group of optical hybrid output channels and to output optical hybrid output light on the group of optical hybrid output channels.

23. The apparatus of claim 22, wherein for each optical input channel of the plurality of optical input channels, the respective group of optical hybrid output channels comprises four optical hybrid output channels for each polarization of the respective optical input channel, wherein the optical hybrid array is configured, for each polarization of each optical input channel of the plurality of optical input channels, to superimpose light of the optical input channel with four instances of the local oscillator light, the four instances having a phase of 0 degrees, 90 degrees, 180 degrees and 270 degrees relative to a first instance among the four instances, respectively, to provide the four optical hybrid output channels for the respective polarization of the respective optical input channel.

24. The apparatus of claim 22, wherein the dispersive optics are configured, for each optical input channel of the plurality of optical input channels, to couple each optical hybrid output channel of the respective group of optical hybrid output channels to a respective set of spectral channels, wherein the spectral channels of the respective set of spectral channels are spectrally and spatially separated from each other.

25. The apparatus of claim 21, wherein the plurality of optical input channels is arranged in a two-dimensional array.

26. The apparatus of claim 21, wherein the optical hybrid array comprises a surface-normal optical hybrid array.

27. The apparatus of claim 21, wherein the optical hybrid array comprises a set of patterned waveplate (PW) planes, wherein the set of PW planes comprises, a first PW plane, a second PW plane, a third PW plane, a fourth PW plane, a fifth PW plane, and a sixth PW plane;
wherein the first PW plane is configured to provide a set of beams by, for each of the optical input channels, performing polarization beam splitting for the respective optical input channel to provide a respective set of optical channel beams and performing beam splitting for a respective set of local oscillator signals associated with the respective optical input channel to provide a set of local oscillator beams;
wherein the second PW plane is configured to bend respective paths of the beams in the set of beams to allow for interference of the optical channel beams and the local oscillator beams at the fourth PW plane;
wherein the third PW plane is configured to convert the set of beams into a set of differential beams by, for each beam in the set of beams, dividing the respective beam into a respective in-phase (I) branch and a respective quadrature (Q) branch;
wherein the fourth PW plane is configured to output a set of optical signals based on mixing of the set of differential beams;
wherein the fifth PW plane is configured to output a set of parallelized optical signals based on parallelization of the optical signals in the set of optical signals; and
wherein the sixth PW plane is configured to output the set of optical hybrid output channels based on conversion of the parallelized optical signals from circular polarization to linear polarization.

28. The apparatus of claim 21, wherein, for each of the optical input signals, the local oscillator light superimposed with the light of the respective optical input channel is obtained based on a local oscillator optical input signal.

29. The apparatus of claim 28, wherein the local oscillator optical input signal is received from a remote transmitter or generated locally by a local laser source.

30. The apparatus of claim 21, wherein the dispersive optics comprise a diffraction grating configured to spectrally decompose the optical hybrid output light into the spectral channels.

31. The apparatus of claim 21, wherein the coherent optical receiver further comprises:
a set of optics elements configured to direct the optical hybrid output light toward the dispersive optics and configured to direct the optical hybrid output light of the spectral channels toward the optical detector array.

32. The apparatus of claim 31, wherein the set of optics elements comprises an optical circulator.

33. The apparatus of claim 32, wherein the optical circulator comprises a Faraday rotator and a 45-degree half waveplate (HWP).

34. The apparatus of claim 31, wherein the set of optics elements comprises a set of collimating lenses, a diffraction grating, a set of spectrometer lenses, and a set of steering elements.

35. The apparatus of claim 31, wherein the set of optics elements comprises a steering device configured to direct the spectral channels to be incident on optical detector elements of the optical detector array, respectively.

36. The apparatus of claim 35, wherein the steering device comprises a passive steering device.

37. The apparatus of claim 35, wherein the steering device comprises an active steering device.

38. The apparatus of claim 37, wherein the active steering device comprises a liquid crystal on silicon (LCoS) device, wherein the LCoS device is configured to apply a grating pattern to control respective steering angles configured to cause the respective spectral channels to be incident on respective optical detector elements of the optical detector array.

39. The apparatus of claim 37, further comprising:
a controller configured to control the active steering device based on feedback from the optical detector array.

40. A method, comprising:
receiving, by a coherent optical receiver, light of a plurality of optical input channels, wherein the optical input channels are spatially separated;
producing, by an optical hybrid array of the coherent optical receiver, optical hybrid output light by superposing local oscillator light with the light of the plurality of optical input channels;
dispersing, by dispersive optics of the coherent optical receiver, the optical hybrid output light into spectral channels that are spectrally and spatially separated; and
detecting, by an optical detector array of the coherent optical receiver for each respective spectral channel of the spectral channels, optical hybrid output light of the respective spectral channel.
